(19) United States
(12) Patent Application Publication
(10) Pub. No.: US 2003/0150279 A1
(43) Pub. Date: Aug. 14, 2003

(54) Ultrasound meter

(75) Inventors: Annulla Lentelius, Stockholm (SE); Jonas Ohrnell, Sundsbruk (SE)

Correspondence Address: SCHIFF HARDIN & WAITE, 6600 SEARS TOWER, 233 S WACKER DR, CHICAGO, IL, 60606-6473, US

(73) Assignee: Siemens Elema AB

(21) Appl. No.: 10/357,808

(22) Filed: Feb. 4, 2003

(30) Foreign Application Priority Data
Feb. 13, 2002 (SE) 0200408-3

(51) Int. Cl. G01F 1/66

(52) U.S. Cl. 73/861.28

(57) ABSTRACT

An ultrasound meter HAS a transmitter, a receiver and a control unit for the transmitter. To improve measurements a feedback connection proceeds between the control unit and the receiver for a signal from the receiver to the control unit, and the control unit regulates energy to the transmitter dependent on the signal fed back from the receiver so that a constant output signal is obtained from the receiver.

### BACKGROUND OF THE INVENTION

1. Field of the Invention

The present invention concerns an ultrasound meter of the type having an ultrasound transmitter, an ultrasound receiver, and a control unit for the transmitter.

2. Description of the Prior Art

Ultrasound measurements are used for different purposes, for example, to determine the flow rates of flowing media and to determine the compositions of gas mixtures, especially binary gas mixtures.

Variations in signal strength of the received signal is a problem that can arise in such uses. Typical causes of these variations are different degrees of acoustic damping with different gas compositions, as well as with different flows and pressures. The variations affect the signal-to-noise ratio and can lead to uncertainty in measurements.

One way to solve this problem is to vary the amplification of the received signal dependent on its magnitude. A large amplification, however, can result in an amplification of the noise.

### SUMMARY OF THE INVENTION

An object of the present invention is to provide an ultrasound meter wherein the above problem is alleviated.

The above object is achieved in accordance with the principles of the present invention in an ultrasound meter having an ultrasound transmitter, an ultrasound receiver, a control unit for the transmitter, and a feedback connection for a signal from the receiver to the control unit, so that the control unit regulates energy to the transmitter dependent on the fed back signal from the receiver to maintain a constant output signal from the receiver.

By regulating the energy supplied to the transmitter dependent on the output signal of the receiver a constant output signal strength is obtained, with an optimal signal-to-noise ratio.

In an embodiment of the inventive ultrasound meter, the input voltage to the transmitter is varied dependent on the output signal from the receiver in order to obtain a constant output signal.

In another embodiment of the inventive ultrasound meter the pulse width of the control pulses to the transmitter is varied dependent on the output signal from the receiver so that a constant output signal is obtained.

The amplitude of the output signal can be measured by determining the rise time for a flank of the output signal to reach a predetermined value. The rise time is then a measure of the strength of the output signal and may be used by the control unit to vary the energy to the transmitter.

### DESCRIPTION OF THE DRAWINGS

FIG. 1 shows an embodiment of the inventive ultrasound meter.

FIG. 2 shows a first way to regulate the energy to the transmitter in the inventive ultrasound meter.

FIG. 3 shows a second way to regulate the energy to the transmitter in the inventive ultrasound meter.

### DESCRIPTION OF THE PREFERRED EMBODIMENTS

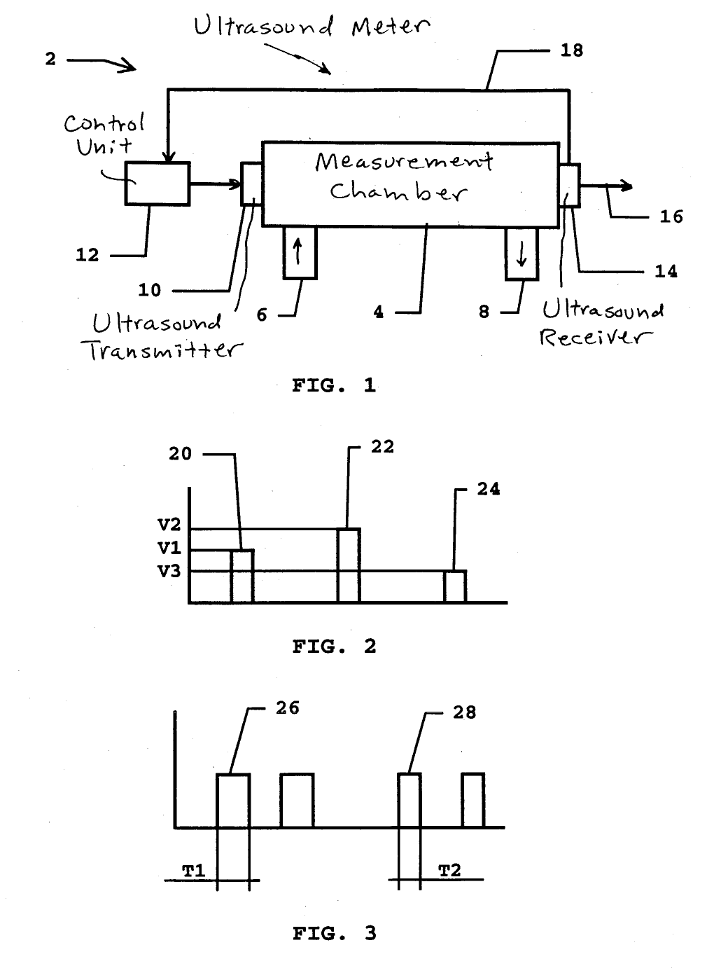

FIG. 1 shows an embodiment of an ultrasound meter 2 according to the invention. The ultrasound meter 2 has a measurement chamber 4 with an inlet 6 for gas and/or liquid and an outlet 8 for the gas and/or liquid. A transmitter 10 emits sound pulses into the measurement chamber 4 under control of a control unit 12. A receiver 14 detects the sound pulses and converts these to electrical signals which are output via an output line 16. A feedback connection 18 from the receiver 14 to the control unit 12 allows the control unit 12 to regulate the energy to the transmitter 10 in relation to the sound pulses that are detected by the receiver 14 in order to maintain a constant signal strength of the electrical signals which are output via the output line 16.

FIG. 2 shows an example of how the control unit 12 of FIG. 1 can be operated to vary the energy to the transmitter 10. FIG. 2 shows a diagram with three energy pulses 20, 22, 24. All pulses 20, 22, 24 have the same pulse width. The first pulse 20 has an amplitude V1. The second pulse 22 has an amplitude V2 which is greater than V1. This is a consequence of the signal received by the receiver 14 being weaker than the constant value which was desired. The third pulse 24 has an amplitude V3 which is lower than V1. This is a consequence of the signal received by the receiver 14 being stronger than the constant value which was desired.

FIG. 3 shows another example by which the energy to the transmitter 10 may be varied. A first pulse train 26, having two identical pulses is shown. The pulse width is T1. In a second pulse train 28 the pulse width has been reduced to T2. The amplitude is identical for all pulses in both pulse trains 26, 28.

FIG. 2 and FIG. 3 show only exemplary designs for how the energy to the transmitter 10 can be varied using different pulse shapes. Other variations will be apparent to those skilled in the art. In principle any pulse and pulse train variation which causes a variation in the supplied energy is suitable.

The signal which is fed back via the feedback connection 18 of FIG. 1 can include one (or more) of a number of different signals. It can include the raw signal that the receiver 14 detects, or an amplified raw signal, or the signal at the output 16, or a signal which represents one or more of the previous signals or their signal strengths. One way to determine signal strength is to determine a rise-time for a signal flank to reach a certain value. The rise-time can therefore constitute the fed back signal.

It is therefore sufficient that a signal representative of the signal strength at the receiver side or a signal from which the signal strength at the receiver side can be determined is fed back to the control unit 12. Whether the main part of the signal processing to determine the signal strength is carried out at the receiver side or in the control unit 12 is immaterial to the realization of an ultrasound meter according to the invention.

Likewise the measurement chamber 4 can have any known form. For example the measurement chamber 4 can be an integral part of a pipe or tube through which gas or liquid flows. Transmitters and receivers thus can be arranged at the pipe or tube wall in a known manner.

It is also immaterial whether the measurement is carried out in order to determine a flow, a gas composition, a temperature or other information determinable from the ultrasound measurement.

Although modifications and changes may be suggested by those skilled in the art, it is the intention of the inventors to embody within the patent warranted hereon all changes and modifications as reasonably and properly come within the scope of their contribution to the art.

We claim as our invention:

1. An ultrasound meter comprising:
an ultrasound transmitter;
an ultrasound receiver;
a control unit connected to said ultrasound transmitter for regulating energy to said ultrasound transmitter; and
a feedback connection from said ultrasound receiver to said control unit for supplying a feedback signal to said control unit, said control unit regulating said energy to said transmitter dependent on said feedback signal to maintain a constant output signal from said ultrasound receiver.

2. An ultrasound meter as claimed in claim 1 wherein said control unit supplies a control pulse, having an amplitude, to said ultrasound transmitter, and wherein said control unit regulates said amplitude of said control pulse dependent on said feedback signal.

3. An ultrasound meter as claimed in claim 1 wherein said control unit supplies a control pulse, having an pulse width, to said ultrasound transmitter, and wherein said control unit regulates said pulse width of said control pulse dependent on said feedback signal.

4. An ultrasound meter as claimed in claim 3 wherein said control pulse comprises a pulse train.
